(19) United States
(12) Patent Application Publication
(10) Pub. No.: US 2023/0150109 A1
(43) Pub. Date: May 18, 2023

(54) STORAGE BAG

(71) Applicant: JENG SHENG CO., LTD., Taichung City (TW)

(72) Inventor: KUO-CHIN CHIANG, Taichung City (TW)

(21) Appl. No.: 17/528,681

(22) Filed: Nov. 17, 2021

(51) Int. Cl. B25H 3/00

(52) U.S. Cl. CPC B25H 3/003; B25H 3/006

(57) ABSTRACT

A storage bag is provided, including: a flexible sheet body, including an inner surface; a fastener, including a base and at least one buckling portion connected to the base; a tool storage member, including a first side wall and a second side wall, the at least one buckling portion being disposed through the flexible sheet body and being inserted within and connected to the first side wall, and the base being positioningly blocked at a side of the flexible sheet, the first side wall being connected to the inner surface, the second side wall extending along an edge of the flexible sheet; wherein when the flexible sheet body is folded about the second side wall to form a bag body, the second side wall serves as an outer side wall of the bag body and is exposed.

### BACKGROUND OF THE INVENTION

### Field of the Invention

The present invention relates to a storage bag.

### Description of the Prior Art

In many operations, such as the assembling, disassembling and connection of devices or structures, hand tools or power tools are often needed to achieve better work efficiency and greatly save manpower and time. Generally speaking, the tools, such as sockets, screwdrivers, screwdriver heads, wrenches or the like, need to be stored in a storage device.

In a conventional storage bag, such as a foldable tool storage bag, a plurality of storage seats are mounted to a flexible sheet body for storing different types of tools. However, in the conventional storage bag, a plurality of blocking walls need to be additionally provided on the flexible sheet body, in order to support the flexible sheet body to form an inner space after the flexible sheet body is folded. Therefore, there are many components, the structure is more complicated, and it is not easy to assemble and manufacture. In addition, the plurality of blocking walls are swingably connected to the flexible sheet body and cannot not be positioned in a fixed position relative to the flexible sheet body, so that each of the plurality of blocking walls cannot serve as a stable support when there is a need for vertical placement of the storage device.

The present invention is, therefore, arisen to obviate or at least mitigate the above-mentioned disadvantages.

### SUMMARY OF THE INVENTION

The main object of the present invention is to provide a storage bag which is simple in structure, and is easy to assemble and manufacture.

To achieve the above and other objects, a storage bag is provided, including: a flexible sheet body, including an inner surface; a fastener, including a base and at least one buckling portion connected to the base, the base extending laterally beyond the at least one buckling portion; a tool storage member, including a first side wall and a second side wall located on different sides, the at least one buckling portion being disposed through the flexible sheet body and being inserted within and connected to the first side wall, and the base being positioningly blocked at a side of the flexible sheet opposite to the inner surface, the first side wall being connected to the inner surface, the second side wall extending along an edge of the flexible sheet and extending in a direction away from the inner surface; wherein when the flexible sheet body is folded about the second side wall to form a bag body, the second side wall serves as an outer side wall of the bag body and is exposed.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram folded according to a preferable embodiment of the present invention;

FIG. 2 is a breakdown drawing of a preferable embodiment of the present invention;

FIG. 3 is a stereogram unfolded according to a preferable embodiment of the present invention;

FIGS. 4 and 5 are drawings showing operation of a preferable embodiment of the present invention;

FIG. 6 is a drawing showing application of a preferable embodiment of the present invention;

FIG. 7 is a drawing showing a storage bag before completely folded according to a preferable embodiment of the present invention; and

FIG. 8 is a stereogram unfolded according to another preferable embodiment of the present invention.

### DETAILED DESCRIPTION OF THE PREFERRED EMBODIMENTS

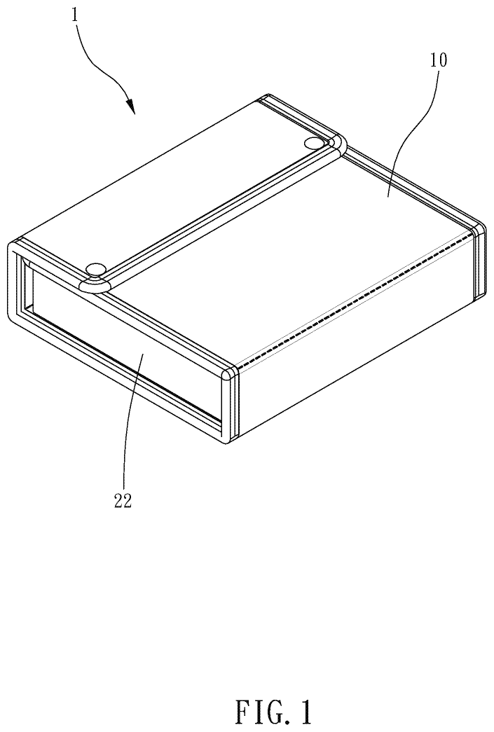

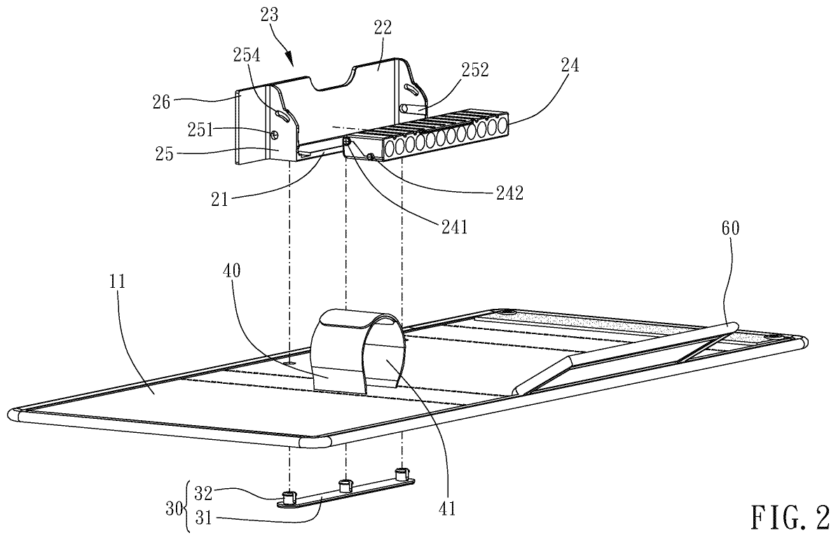

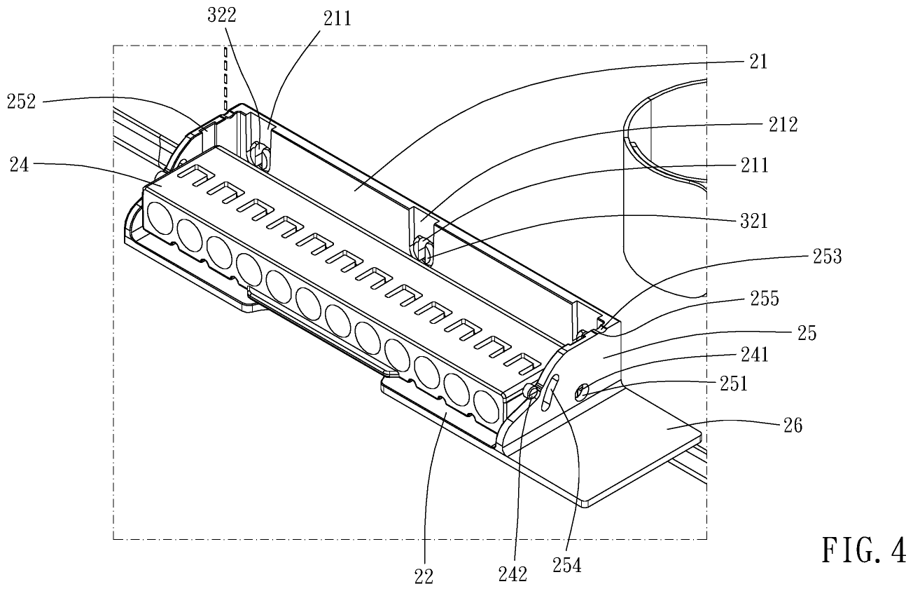

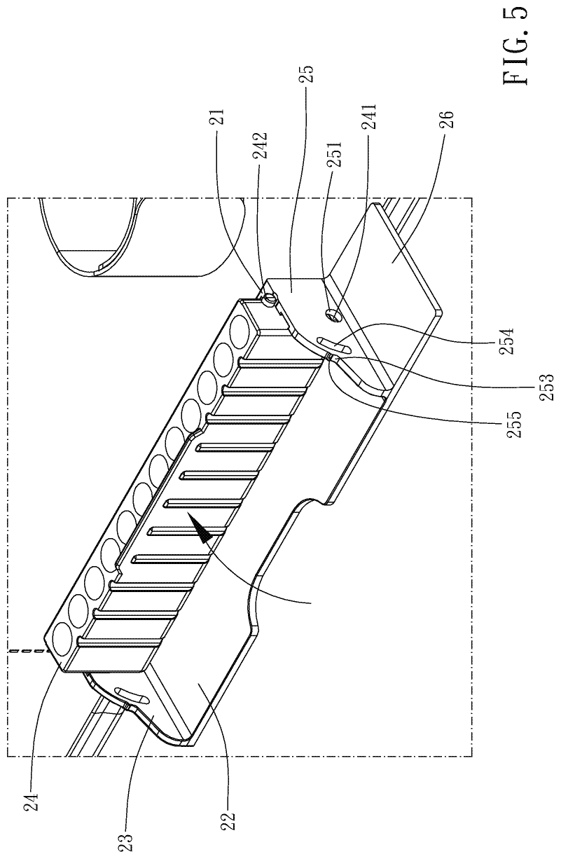

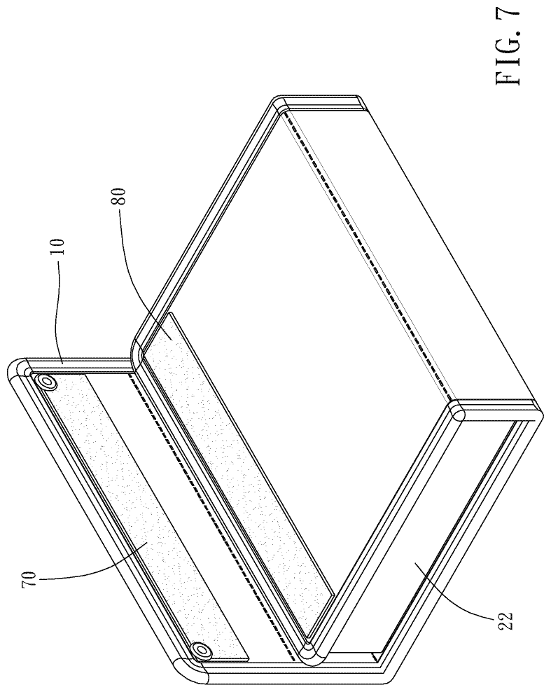

Please refer to FIGS. 1 to 7 for a preferable embodiment of the present invention. A storage bag 1 of the present invention includes a flexible sheet body 10, a tool storage member 20 and a fastener 30.

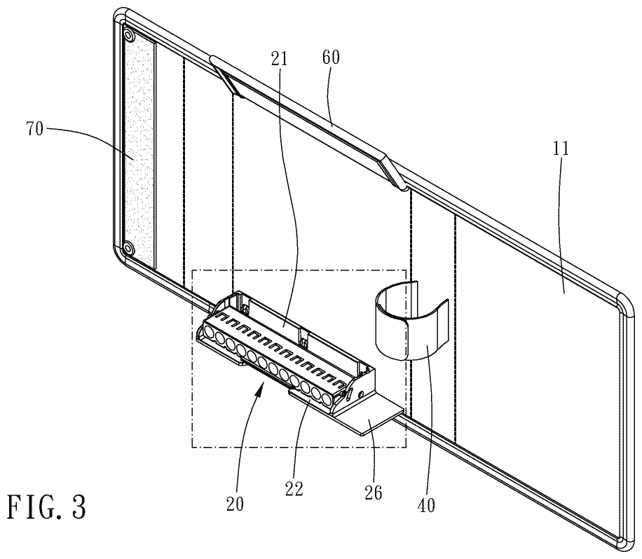

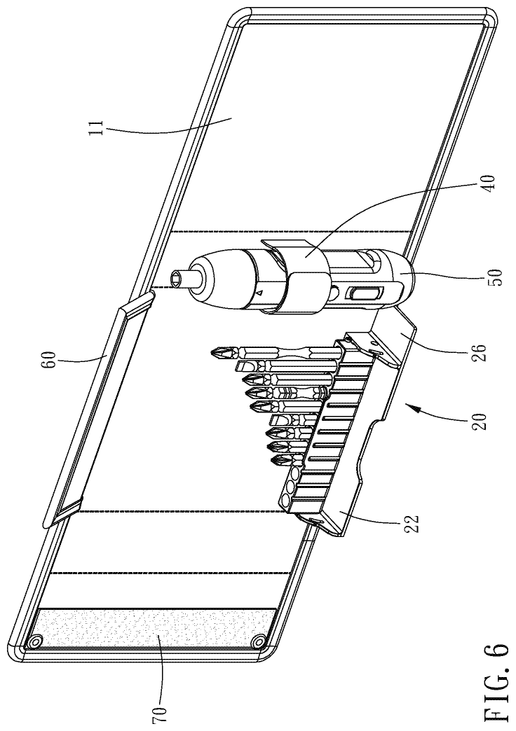

The flexible sheet body 10 includes an inner surface 11; the fastener 30 includes a base 31 and at least one buckling portion 32 connected to the base 311, and the base 31 extends laterally beyond the at least one buckling portion 32; the tool storage member 20 includes a first side wall 21 and a second side wall 22 located on different sides, the at least one buckling portion 32 is disposed through the flexible sheet body 10 and is inserted within and connected to the first side wall 21, the base 31 is positioningly blocked at a side of the flexible sheet body 10 opposite to the inner surface 11, the first side wall 21 is connected to the inner surface 11, and the second side wall 22 extends along an edge of the flexible sheet body 10 and extends in a direction away from the inner surface 11; and when the flexible sheet body 10 is folded about the second side wall 22 to form a bag body, the second side wall 22 serves as an outer side wall of the storage bag 1 and is exposed. Whereby, the second side wall 22 serves as the outer side wall of the storage bag 1 to support the flexible sheet body 10 to form an inner space for storage without any additional blocking wall, and thus it is simple in structure, and is easy to assemble and manufacture. Moreover, when the flexible sheet body 10 is unfolded, the second side wall 22 can be configured for supporting the flexible sheet body 10 so that the flexible sheet body 10 can stand uprightly on a face (as shown in FIGS. 3 and 6).

The first side wall 21 includes at least one buckling hole 211, and the at least one buckling portion 32 is inserted and buckled within the at least one buckling hole 211. Preferably, the first side wall 21 includes a plurality of buckling holes 211, the plurality of buckling holes 211 are arranged equidistantly, the fastener 30 includes a plurality of the buckling portions 32 arranged equidistantly, and each of the plurality of the buckling portions 32 is detachably inserted and buckled within one of the plurality of the buckling holes 211, for easy, quick and stable assembling. The base 31 is connected to the plurality of the buckling portions 32 laterally, which provides a large abutment area against the flexible sheet body 10 so that it enhances combination of the tool storage member 20 and the flexible sheet body 10 and make the plurality of the buckling portions 32 uneasy to detach from the flexible sheet body 10. Preferably, the first side wall 21 further includes at least one recession 212 which is in communication with the at least one buckling hole 211 and open at an end face of the first side wall 21. Specifically, the first side wall 21 includes a plurality of recessions 212 which are respectively in communication with the plurality of buckling holes 211 and open at the end face of the first side wall 21. Each of the plurality of the buckling portions 32 includes a hooking end 321 engaged within one of the plurality of recessions 212 so that the at least one fastener 30 is not or less protrusive beyond the at least one recession 212.

The tool storage member 20 further includes a mounting seat 23 and a storage seat 24 movably disposed on the mounting seat 23. Specifically, the mounting seat 23 includes the first side wall 21 and the second side wall 22, the mounting seat 23 further includes at least one third side wall 25 located on a side different from the different sides on which the first side wall 21 and the second side wall 22 are located, and the storage seat 24 is rotatably connected to the at least one third side wall 25 and located between the first, second and third side wall 21, 22, 25. In this embodiment, the mounting seat 23 includes two third side walls 25, and each of the two third side walls 25 is connected to corresponding ends of the first side wall 21 and the second side wall 22, for stable connection of the storage seat 24. The third side wall 25 includes at least one pivoting hole 251 and at least one guiding groove 252 which is in communication with the at least one pivoting hole 251 and open at an end face of the third side wall 25, and the storage seat 24 includes at least one pivoting portion 241 rotatably connected to the at least one pivoting hole 251, so that the storage seat 24 can be rotated at an angle for easy access to tool such as driver bits, sockets, connection rod or the like. In this embodiment, the storage seat 24 includes two pivoting portions 241, and the third side wall 25 includes two pivoting holes 251 and two guiding grooves 252 which are respectively in communication with the two pivoting holes 251 and open at the end face of the third side wall 25. The two pivoting portions 241 are slidable along the two guiding grooves 252 to be inserted into the two pivoting holes 251, which is easy and quick to assemble.

Preferably, the at least one third side wall 25 further includes at least one concave 253, and the storage seat 24 further includes a projection 242 disengageably engaged within the at least one concave 253 in a rotation direction of the storage seat 24, for positioned the storage seat 24. A peripheral portion of each of the at least one concave 253 includes a protrusion 255 so that the projection 242 can sufficiently and stably engaged within the concave 253. The at least one third side wall 25 further includes at least one slot 254 adjacent to the at least one concave 253. Preferably, an extent of each said slot 254 is larger than a span of the concave 253, thus allowing some deformation of the third side wall 25 to facilitate engagement of the projection 242 into the at least one concave 253 and disengagement of the projection 242 from the at least one concave 253.

Preferably, the tool storage member 20 further includes an extension wall 26 extending from the second side wall 22, a second tool storage member 40 is disposed on the inner surface 11 of the flexible sheet body 10, and the second tool storage member 40 includes an insertion hole 41 for receiving a tool 50 such as power tool, wrench, driving tool or the like. When the flexible sheet body 10 is folded to form the bag body, the insertion hole 41 corresponds to the extension wall 26, and the third side wall 25 and the extension wall 26 are in an L-shaped configuration and form a space for receiving the tool 50. When the flexible sheet body 10 is unfolded, the extension wall 26 and the second side wall 22 provides a large supporting area, so that the flexible sheet body 10 can stand uprightly and stably (as shown in FIGS. 3 and 6).

Preferably, a blocking wall 60 is connected to the inner surface 11, and when the flexible sheet body 10 is folded to form the bag body the bag body, the blocking wall 60 faces the second side wall 22 and serves as another outer side wall of the storage bag 1, and thus the flexible sheet body 10 is well supported to provide a sufficient space for storage. Preferably, a first engagement portion 70 is disposed on the inner surface 11, and a second engagement portion 80 is disposed on an outer surface of the flexible sheet body 10. When the flexible sheet body 10 is folded to form the bag body, the first engagement portion 70 and the second engagement portion 80 are releasably secured with each other, thus effectively maintaining the shape and configuration of the flexible sheet body 10 and the storage bag 1. The first engagement portion 70 and the second engagement portion 80 may be provided with a male-female structure, a hook-and-loop structure, re-adhesive structure, magnetic components, or any mechanism that can be positioned and connected to each other.

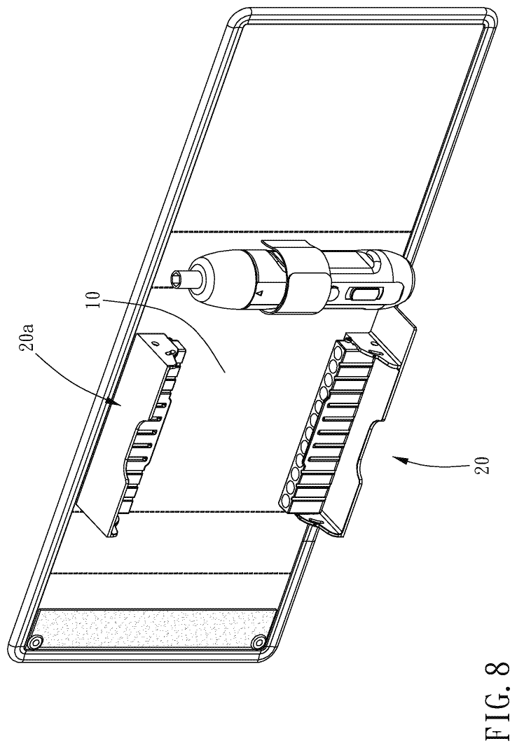

In an alternative embodiment as shown in FIG. 8, none of blocking wall is disposed on the flexible sheet body 10, the storage bag includes another tool storage member 20a, and the tool storage member 20a and the tool storage member 20 are located at opposing sides of the flexible sheet body 10 so that it can be used to receive more tools. The tool storage member 20a and the tool storage member 20 may be identical or unidentical.

Although particular embodiments of the invention have been described in detail for purposes of illustration, various modifications and enhancements may be made without departing from the spirit and scope of the invention. Accordingly, the invention is not to be limited except as by the appended claims.

1. A storage bag, including:
a flexible sheet body, including an inner surface;
a fastener, including a base and at least one buckling portion connected to the base, the base extending laterally beyond the at least one buckling portion; and
a tool storage member, including a first side wall and a second side wall located on different sides, the at least one buckling portion being disposed through the flexible sheet body and being inserted within and connected to the first side wall, the base being positioningly blocked at and entirely exposed on a side of the flexible sheet body opposite to the inner surface, the first side wall being connected to the inner surface, the second side wall extending along an edge of the flexible sheet body and extending in a direction away from the inner surface;
wherein the first side wall includes a plurality of buckling holes, the plurality of buckling holes are arranged equidistantly, the fastener is integrally formed of one piece, the at least one buckling portion includes a plurality of the buckling portions which are arranged equidistantly and integrally connected to the base, each of the plurality of the buckling portions is detachably inserted and buckled within one of the plurality of the buckling holes, each of the plurality of the buckling portions includes a hooking end and a slot which is slotted on the hooking end, open diametrically on a circumferential surface of the hooking end and extends within the first side wall, the hooking end is hooked on the first side wall, and the slots of the plurality of the buckling portions extend in parallel;
wherein when the flexible sheet body is folded about the second side wall to form a bag body, the second side wall serves as an outer side wall of the storage bag and is exposed.

2. The storage bag of claim 1, wherein the tool storage member further includes a mounting seat and a storage seat movably disposed on the mounting seat.

3. The storage bag of claim 2, wherein the mounting seat includes the first side wall and the second side wall, the mounting seat further includes at least one third side wall located on a side different from the different sides on which the first side wall and the second side wall are located, and the storage seat is rotatably connected to the at least one third side wall and located between the first, second and third side walls.

4. The storage bag of claim 3, wherein the at least one third side wall includes at least one concave, and the storage seat includes a projection disengageably engaged within the at least one concave in a rotation direction of the storage seat.

5. The storage bag of claim 4, wherein the at least one third side wall further includes at least one slot adjacent to the at least one concave.

6. (canceled)

7. The storage bag of claim 1, wherein the first side wall further includes at least one recession which is in communication with the at least one buckling hole and open at an end face of the first side wall.

8. The storage bag of claim 3, wherein the third side wall includes at least one pivoting hole and at least one guiding groove which is in communication with the at least one pivoting hole and open at an end face of the third side wall, and the storage seat includes at least one pivoting portion rotatably connected to the at least one pivoting hole.

9. The storage bag of claim 5, wherein the at least one third side wall includes two third side walls, each of the two third side walls is connected to corresponding ends of the first side wall and the second side wall; a peripheral portion of each of the at least one concave includes a protrusion; the first side wall further includes a plurality of recessions which are respectively in communication with the plurality of buckling holes and open at an end face of the first side wall, the hooking end of each of the plurality of the buckling portions is engaged within one of the plurality of recessions; the third side wall includes two pivoting holes and two guiding grooves which are respectively in communication with the two pivoting holes and open at an end face of the third side wall, the storage seat includes two pivoting portions; a blocking wall is connected to the inner surface, and when the flexible sheet body is folded to form the bag body, the blocking wall faces the second side wall and serves as another outer side wall of the storage bag; a first engagement portion is disposed on the inner surface, a second engagement portion is disposed on an outer surface of the flexible sheet body, and when the flexible sheet body is folded to form the bag body, the first engagement portion and the second engagement portion are releasably secured with each other.

10. The storage bag of claim 1, wherein the tool storage member further includes an extension wall extending from the second side wall, a second tool storage member is disposed on the inner surface of the flexible sheet body, the second tool storage member includes an insertion hole, and when the flexible sheet body is folded to form the bag body, the insertion hole corresponds to the extension wall.
